(19) United States
(12) Patent Application Publication
(10) Pub. No.: US 2022/0033226 A1
(43) Pub. Date: Feb. 3, 2022

(54) AUTONOMOUS ELEVATOR CAR MOVERS AND TRACTION SURFACES THEREFOR, CONFIGURED WITH TRACTION INCREASING AND GUIDANCE ENHANCING IMPLEMENTS

(71) Applicant: Otis Elevator Company, Farmington, CT (US)

(72) Inventors: Kiron Bhaskar, Farmington, CT (US); Sam Thieu Wong, Bridgeport, CT (US); Brad Guilani, Woodstock Valley, CT (US)

(21) Appl. No.: 16/943,049

(22) Filed: Jul. 30, 2020

(51) Int. Cl. B66B 11/04; B66B 9/02; B66B 5/02

(52) U.S. Cl. CPC B66B 11/0407; B66B 2201/307; B66B 5/02; B66B 9/02

(57) ABSTRACT

Disclosed is a ropeless elevator system having: a car mover operationally connected to an elevator car, the car mover configured to move along a car mover track in a hoistway lane, thereby moving the elevator car along the hoistway lane, wherein the car mover has a first tire of a first wheel that is configured to engage the car mover track when the car mover moves along the car mover track, wherein one or more of the first tire and the car mover track has an engagement feature for increasing traction between the first tire and the car mover track.

### BACKGROUND

Embodiments described herein relate to a multi-car elevator system and more specifically to autonomous elevator car movers and traction surfaces therefor, configured with traction increasing and guidance enhancing implements.

An autonomous elevator car mover may use motor-driven wheels to propel the elevator car up and down on vertical I-beam tracks. Two elements to this system include the elevator car which will be guided by rollers guides on traditional T-rails, and the autonomous car mover which will house two (2) to four (4) motor-driven wheels. A goal of the connection between the car mover wheels and the I-beam track includes maximizing friction between these elements. In addition, to the extent feasible, another goal is to minimize normal forces required between the car mover wheels and the I-beam tracks while maximizing friction between these elements.

### BRIEF SUMMARY

Disclosed is a ropeless elevator system including: a car mover operationally connected to an elevator car, the car mover configured to move along a car mover track in a hoistway lane, thereby moving the elevator car along the hoistway lane, wherein the car mover includes a first tire of a first wheel that is configured to engage the car mover track when the car mover moves along the car mover track, wherein one or more of the first tire and the car mover track includes an engagement feature for increasing traction between the first tire and the car mover track.

In addition to one or more of the above disclosed aspects, or as an alternate, the first tire includes the engagement feature, wherein the engagement feature includes a first coil winding configured for being powered to provide one or more of heat and magnetic flux.

In addition to one or more of the above disclosed aspects, or as an alternate, the first coil winding is configured for being powered to provide heat and a second coil winding configured for being powered to provide magnetic flux.

In addition to one or more of the above disclosed aspects, or as an alternate, a controller of the car mover is operationally connected to the first coil winding and configured to direct power to the first coil winding depending on one or more of time, a distance between to the car mover track and the car mover, a temperature of the first tire, and slippage between the first tire and the car mover track.

In addition to one or more of the above disclosed aspects, or as an alternate, a sensor is operationally connected to the car mover and configured to provide sensor data indicative of one or more of the distance between the car mover track and the car mover, the temperature of the first tire, and slippage between the first tire and the car mover track.

In addition to one or more of the above disclosed aspects, or as an alternate, the sensor transmits the sensor data to the controller directly, via a wireless network or via a cloud service, and wherein the sensor data is analyzed in whole or part at one or more of the sensor, the cloud service and the controller.

In addition to one or more of the above disclosed aspects, or as an alternate, the first coil winding receives power from a motor that drives the first wheel, wherein the motor is operationally connected to the controller.

In addition to one or more of the above disclosed aspects, or as an alternate, the first tire engages a first side of the car mover track; and the car mover includes a second tire of a second wheel that engages a second side of the car mover track, wherein the second tire includes a second tire coil winding configured for being powered to provide magnetic flux so that the first tire and the second tire are either attracted toward or repelled away from each other.

In addition to one or more of the above disclosed aspects, or as an alternate, the car mover track includes a track engagement feature that is configured to enhance one or more of traction and guidance when engaged by the first tire.

In addition to one or more of the above disclosed aspects, or as an alternate, the track engagement feature is one or more of: a track cross section of the car mover track that forms a diamond profile or a circular profile; and a track web cross section of the car mover track that forms a convex profile, a concave profile, or a semi-circular profile on one side or both sides of the of the car mover track.

In addition to one or more of the above disclosed aspects, or as an alternate, the first tire includes a tire engagement feature and the car mover track includes a track engagement feature, wherein the tire engagement feature and the track engagement feature are located and shaped to complement each other and engage each other when the car mover moves along the car mover track.

In addition to one or more of the above disclosed aspects, or as an alternate, the tire engagement feature is one of protrusions and impressions formed circumferentially along an outer annular surface of the first tire; and the track engagement feature is another of protrusions and impressions along the car mover track.

In addition to one or more of the above disclosed aspects, or as an alternate, the tire engagement feature is axially centered or offset from an axial center of the first tire; or the tire engagement feature and the track engagement feature form a triangular waveform profile.

In addition to one or more of the above disclosed aspects, or as an alternate, the car mover track includes the engagement feature, wherein the engagement feature is one or more of: a surface coating; a surface finish; a surface contour that centers the first tire on the car mover track when the car mover moves along the car mover track, and complimentary alignment features between track sections.

Further disclosed is a method of operating a ropeless elevator system including: powering a first coil winding in a first tire of a first wheel of a car mover operationally connected to an elevator car, wherein the car mover configured to move along a car mover track in a hoistway lane, thereby moving the elevator car along the hoistway lane; and providing one or more of heat and magnetic flux from powering the first coil winding.

In addition to one or more of the above disclosed aspects, or as an alternate, the method includes a controller of the car mover, operationally connected to the first coil winding, directing power the first coil winding depending on one or more of time, a distance between to the car mover track and the car mover, a temperature of the first tire, and slippage between the first tire and the car mover track.

In addition to one or more of the above disclosed aspects, or as an alternate, the method includes a sensor, operationally connected to the car mover, providing sensor data indicative of one or more of the distance between the car mover track and the car mover, a temperature of the first tire, and slippage between the first tire and the car mover track.

In addition to one or more of the above disclosed aspects, or as an alternate, the method includes the sensor transmitting the sensor data to the controller, directly, via a wireless network or via a cloud service, wherein the sensor data is analyzed in whole or part at one or more of the sensor, the cloud service and the controller.

In addition to one or more of the above disclosed aspects, or as an alternate, the method includes the first coil winding receiving power from a motor that drives the first wheel, wherein the motor is operationally connected to the controller.

In addition to one or more of the above disclosed aspects, or as an alternate, the method includes the first tire engaging a first side of the car mover track; and powering a second tire coil winding in a second tire of a second wheel of the car mover, the second tire engaging a second side of the car mover track, to provide magnetic flux so that the first tire and the second tire are selectively attracted toward and repelled away from each other.

### BRIEF DESCRIPTION OF THE DRAWINGS

The subject matter which is regarded as the invention is particularly pointed out and distinctly claimed in the claims at the conclusion of the specification. The foregoing and other features and advantages of the invention are apparent from the following detailed description taken in conjunction with the accompanying drawings in which:

FIG. 1 is a schematic of elevator cars and car movers in a hoistway lane according to an embodiment;

FIG. 2 shows a car mover according to an embodiment;

FIG. 3 shows a car mover where wheels are equipped with engagement features in the form of coil windings to provide heat and electromagnetic properties;

FIG. 4 shows portions of a car mover, where wheels and a web of the car mover track have engagement features in the form of complimentary impressions in the wheels and protrusions in the web, to provide enhanced traction;

FIG. 5 shows portions of a car mover, where wheels and a web of the car mover track have engagement features in the form of complimentary impressions in the web and protrusions in the wheels, to provide enhanced traction;

FIG. 6A shows portions of a car mover, where tires and a web of the car mover track have engagement features in the form of complimentary wedge shaped protrusions in the web and impressions in the tires, to provide enhanced traction;

FIG. 6B shows tires and a web of the car mover track, where the web has engagement features in the form of semi-circular shaped protrusions on both sides of the web to provide enhanced traction;

FIG. 6C shows tires and the car mover track having engagement features in the form of a wedge or diamond shaped track and complementary impressions in the tires, to provide enhanced traction;

FIG. 6D shows tires and the car mover track having engagement features in the form of a track with a circular section and complementary impressions in the tires, to provide enhanced traction;

FIG. 6E shows tires and a web of the car mover track, where the web has engagement features in the form of a convex cross section, to provide enhanced traction;

FIG. 6F shows tires and a web of the car mover track, where the web has engagement features in the form of a concave cross section, to provide enhanced traction;

FIG. 6G shows tires and a web of the car mover track, where the has engagement features in the form of a semi-circular shaped protrusion on one side of the web, to enhance guidance;

FIG. 7 shows the car mover track provided with engagement features in the form of a surface treatment and/or finishing to increase friction, and wherein the car mover track is formed with a concave shape and sections of the car mover track include tongue and grove alignment features; and

FIG. 8 shows the car mover track of FIG. 7 along section lines 8-8; and

FIG. 9 shows a method of operating a ropeless elevator system according to an embodiment.

### DETAILED DESCRIPTION

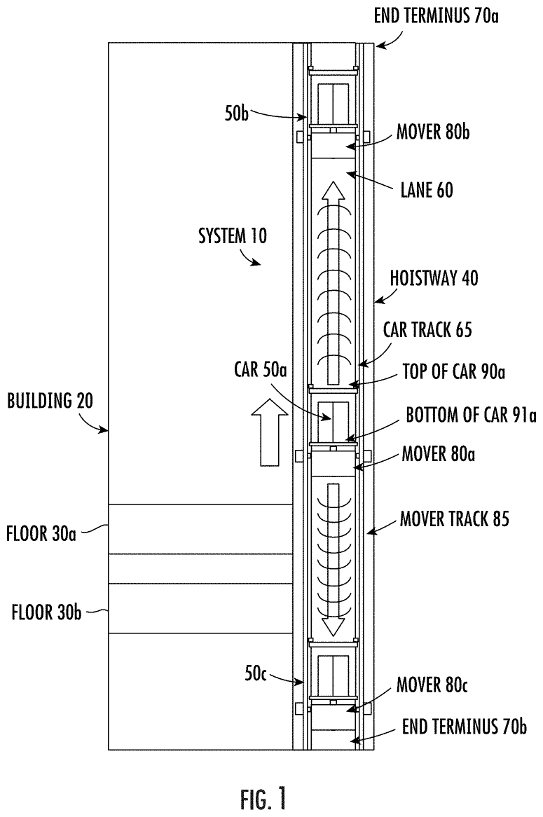

FIG. 1 depicts a self-propelled or ropeless elevator system (elevator system) 10 in an exemplary embodiment that may be used in a structure or building 20 having multiple levels or floors 30a, 30b. Elevator system 10 includes a hoistway 40 (or elevator shaft) defined by boundaries carried by the building 20, and a plurality of cars 50a-50c adapted to travel in a hoistway lane 60 along an elevator car track 65 (which may be a T-rail) in any number of travel directions (e.g., up and down). The cars 50a-50c are generally the same so that reference herein shall be to the elevator car 50a. The hoistway 40 may also include a top end terminus 70a and a bottom end terminus 70b.

For each of the cars 50a-50c, the elevator system 10 includes one of a plurality of car mover systems (car movers) 80a-80c (otherwise referred to as a beam climber system, or beam climber, for reasons explained below). The car movers 80a-80c are generally the same so that reference herein shall be to the car 50a. The car mover 80a is configured to move along a car mover track 85 (which may be an I-beam) to move the elevator car 50a along the hoistway lane 60, and to operate autonomously. The car mover 80a may positioned to engage the top 90a of the car 50a, the bottom 91a of the car 50a or both. In FIG. 1, the car mover 80a engages the bottom 91a of the car 50a.

FIG. 2 is a perspective view of an elevator system 10 including the elevator car 50a, a car mover 80a, a controller 115, and a power source 120. Although illustrated in FIG. 1 as separate from the car mover 80a, the embodiments described herein may be applicable to a controller 115 included in the car mover 80a (i.e., moving through an hoistway 40 with the car mover 80a) and may also be applicable a controller located off of the car mover 80a (i.e., remotely connected to the car mover 80a and stationary relative to the car mover 80a).

Although illustrated in FIG. 1 as separate from the car mover 80a, the embodiments described herein may be applicable to a power source 120 included in the car mover 80a (i.e., moving through the hoistway 40 with the car mover 80a) and may also be applicable to a power source located off of the car mover 80a (i.e., remotely connected to the car mover 80a and stationary relative to the car mover 80a).

The car mover 80a is configured to move the elevator car 50a within the hoistway 40 and along guide rails 109a, 109b that extend vertically through the hoistway 40. In an embodiment, the guide rails 109a, 109b are T-beams. The car mover 80a includes one or more electric motors 132a, 132b. The electric motors 132a, 132b are configured to move the car mover 80a within the hoistway 40 by rotating one or more motorized wheels 134a, 134b that are pressed against a guide beam 111a, 111b that form the car mover track 85 (FIG. 1). In an embodiment, the guide beams 111a, 111b are I-beams. It is understood that while an I-beam is illustrated any beam or similar structure may be utilized with the embodiment described herein. Friction between the wheels 134a, 134b, 134c, 134d driven by the electric motors 132a, 132b allows the wheels 134a, 134b, 134c, 134d climb up 21 and down 22 the guide beams 111a, 111b. The guide beam extends vertically through the hoistway 40. It is understood that while two guide beams 111a, 111b are illustrated, the embodiments disclosed herein may be utilized with one or more guide beams. It is also understood that while two electric motors 132a, 132b are illustrated, the embodiments disclosed herein may be applicable to car movers 80a having one or more electric motors. For example, the car mover 80a may have one electric motor for each of the four wheels 134a, 134b, 134c, 134d (generically wheels 134). The electrical motors 132a, 132b may be permanent magnet electrical motors, asynchronous motor, or any electrical motor known to one of skill in the art. In other embodiments, not illustrated herein, another configuration could have the powered wheels at two different vertical locations (i.e., at bottom and top of an elevator car 50a).

The first guide beam 111a includes a web portion 113a and two flange portions 114a. The web portion 113a of the first guide beam 111a includes a first surface 112a and a second surface 112b opposite the first surface 112a. A first wheel 134a is in contact with the first surface 112a and a second wheel 134b is in contact with the second surface 112b. The first wheel 134a may be in contact with the first surface 112a through a tire 135 and the second wheel 134b may be in contact with the second surface 112b through a tire 135. The first wheel 134a is compressed against the first surface 112a of the first guide beam 111a by a first compression mechanism 150a and the second wheel 134b is compressed against the second surface 112b of the first guide beam 111a by the first compression mechanism 150a. The first compression mechanism 150a compresses the first wheel 134a and the second wheel 134b together to clamp onto the web portion 113a of the first guide beam 111a.

The first compression mechanism 150a may be a metallic or elastomeric spring mechanism, a pneumatic mechanism, a hydraulic mechanism, a turnbuckle mechanism, an electromechanical actuator mechanism, a spring system, a hydraulic cylinder, a motorized spring setup, or any other known force actuation method.

The first compression mechanism 150a may be adjustable in real-time during operation of the elevator system 10 to control compression of the first wheel 134a and the second wheel 134b on the first guide beam 111a. The first wheel 134a and the second wheel 134b may each include a tire 135 to increase traction with the first guide beam 111a.

The first surface 112a and the second surface 112b extend vertically through the hoistway 40, thus creating a track for the first wheel 134a and the second wheel 134b to ride on. The flange portions 114a may work as guardrails to help guide the wheels 134a, 134b along this track and thus help prevent the wheels 134a, 134b from running off track.

The first electric motor 132a is configured to rotate the first wheel 134a to climb up 21 or down 22 the first guide beam 111a. The first electric motor 132a may also include a first motor brake 137a to slow and stop rotation of the first electric motor 132a.

The first motor brake 137a may be mechanically connected to the first electric motor 132a. The first motor brake 137a may be a clutch system, a disc brake system, a drum brake system, a brake on a rotor of the first electric motor 132a, an electronic braking, an Eddy current brakes, a Magnetorheological fluid brake or any other known braking system. The beam climber system 130 may also include a first guide rail brake 138a operably connected to the first guide rail 109a. The first guide rail brake 138a is configured to slow movement of the beam climber system 130 by clamping onto the first guide rail 109a. The first guide rail brake 138a may be a caliper brake acting on the first guide rail 109a on the beam climber system 130, or caliper brakes acting on the first guide rail 109 proximate the elevator car 50a.

The second guide beam 111b includes a web portion 113b and two flange portions 114b. The web portion 113b of the second guide beam 111b includes a first surface 112c and a second surface 112d opposite the first surface 112c. A third wheel 134c is in contact with the first surface 112c and a fourth wheel 134d is in contact with the second surface 112d. The third wheel 134c may be in contact with the first surface 112c through a tire 135 and the fourth wheel 134d may be in contact with the second surface 112d through a tire 135. A third wheel 134c is compressed against the first surface 112c of the second guide beam 111b by a second compression mechanism 150b and a fourth wheel 134d is compressed against the second surface 112d of the second guide beam 111b by the second compression mechanism 150b. The second compression mechanism 150b compresses the third wheel 134c and the fourth wheel 134d together to clamp onto the web portion 113b of the second guide beam 111b.

The second compression mechanism 150b may be a spring mechanism, turnbuckle mechanism, an actuator mechanism, a spring system, a hydraulic cylinder, and/or a motorized spring setup. The second compression mechanism 150b may be adjustable in real-time during operation of the elevator system 10 to control compression of the third wheel 134c and the fourth wheel 134d on the second guide beam 111b. The third wheel 134c and the fourth wheel 134d may each include a tire 135 to increase traction with the second guide beam 111b.

The first surface 112c and the second surface 112d extend vertically through the shaft 117, thus creating a track for the third wheel 134c and the fourth wheel 134d to ride on. The flange portions 114b may work as guardrails to help guide the wheels 134c, 134d along this track and thus help prevent the wheels 134c, 134d from running off track.

The second electric motor 132b is configured to rotate the third wheel 134c to climb up 21 or down 22 the second guide beam 111b. The second electric motor 132b may also include a second motor brake 137b to slow and stop rotation of the second motor 132b. The second motor brake 137b may be mechanically connected to the second motor 132b. The second motor brake 137b may be a clutch system, a disc brake system, drum brake system, a brake on a rotor of the second electric motor 132b, an electronic braking, an Eddy current brake, a Magnetorheological fluid brake, or any other known braking system. The beam climber system 130 includes a second guide rail brake 138b operably connected to the second guide rail 109b. The second guide rail brake 138b is configured to slow movement of the beam climber system 130 by clamping onto the second guide rail 109b. The second guide rail brake 138b may be a caliper brake acting on the first guide rail 109a on the beam climber system 130, or caliper brakes acting on the first guide rail 109a proximate the elevator car 50a.

The elevator system 10 may also include a position reference system 113. The position reference system 113 may be mounted on a fixed part at the top of the hoistway 40, such as on a support or guide rail 109, and may be configured to provide position signals related to a position of the elevator car 50a within the hoistway 40. In other embodiments, the position reference system 113 may be directly mounted to a moving component of the elevator system (e.g., the elevator car 50a or the car mover 80a), or may be located in other positions and/or configurations.

The position reference system 113 can be any device or mechanism for monitoring a position of an elevator car within the elevator shaft 117. For example, without limitation, the position reference system 113 can be an encoder, sensor, accelerometer, altimeter, pressure sensor, range finder, or other system and can include velocity sensing, absolute position sensing, etc., as will be appreciated by those of skill in the art.

The controller 115 may be an electronic controller including a processor 116 and an associated memory 119 comprising computer-executable instructions that, when executed by the processor 116, cause the processor 116 to perform various operations. The processor 116 may be, but is not limited to, a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory 119 may be but is not limited to a random access memory (RAM), read only memory (ROM), or other electronic, optical, magnetic or any other computer readable medium.

The controller 115 is configured to control the operation of the elevator car 50a and the car mover 80a. For example, the controller 115 may provide drive signals to the car mover 80a to control the acceleration, deceleration, leveling, stopping, etc. of the elevator car 50a.

The controller 115 may also be configured to receive position signals from the position reference system 113 or any other desired position reference device.

When moving up 21 or down 22 within the hoistway 40 along the guide rails 109a, 109b, the elevator car 50a may stop at one or more floors 30a, 30b as controlled by the controller 115. In one embodiment, the controller 115 may be located remotely or in the cloud. In another embodiment, the controller 115 may be located on the car mover 80a

The power supply 120 for the elevator system 10 may be any power source, including a power grid and/or battery power which, in combination with other components, is supplied to the car mover 80a. In one embodiment, power source 120 may be located on the car mover 80a. In an embodiment, the power supply 120 is a battery that is included in the car mover 80a. The elevator system 10 may also include an accelerometer 107 attached to the elevator car 50a or the car mover 80a. The accelerometer 107 is configured to detect an acceleration and/or a speed of the elevator car 50a and the car mover 80a.

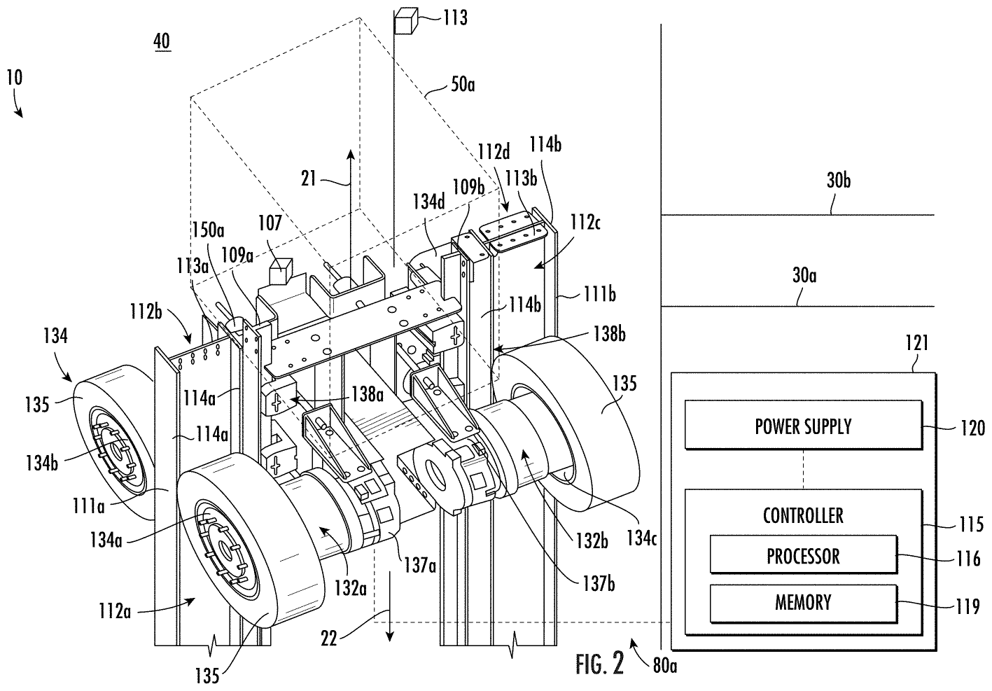

Turning now to FIG. 3, an embodiment is disclosed in which one or more of the tires 135 of a respective one or more of the wheels 134 of the car mover 80a may include tire engagement features (or tire engagement feature) 200a as traction increasing implements. The tire engagement features 200a may be in the form of coil windings 210 configured receive power and provide an electromagnet. For simplicity, the one or more of the tires 135 and respective wheels 134 will be referred to as the first tire 135a and the first wheel 134a, and the coil windings 210 for first tire 135a will be referred to as a first coil winding 210a.

When using solid rubber tires (though using traditional automobile type rubber tires is within the scope of the disclosure) for the first tire 135a, the tire traction may depend on clamping force, surface area, rubber compound, and tread pattern against the car mover track 85 (e.g., an I-beam). The car mover track 85 may be formed from a ferrous material. Decreasing temperatures may lower coefficient of friction between the first tire 135a and the car mover track 85, resulting in a loss of traction. Moisture and oils on the first tire 135a and on the contact surface of the car mover track 85 (e.g., the web 113 of the I-beam) may also result in a loss of traction.

Thus, as indicated, the first tire 135a may incorporate the first coil winding 210a, e.g., embedded in the rubber compound that forms the first tire 135a. The first coil winding 210a may both heat the first tire 135a and optionally generate a magnetic field. In one embodiment, the first coil winding 210a may be used for heating and a second coil winding 210b may be utilized for generating a magnetic field. As the first and second coil windings 210a, 210b may be the same, for simplicity, reference herein shall be to the first coil winding 210a. The magnetic field may be generated throughout a run cycle of a car mover 80a, e.g., provided through the motor 132a for the first wheel 134a. In one embodiment, any number of coil windings may be used.

Powering the first coil winding 210a may be controlled by the car mover controller 115 and may be dependent on one or more of time, ambient temperature, tire temperature, slippage of the first tire 135a against the car mover track 85, and distance from the car mover track. For example, a difference in relative rotational speed between the first wheel 134a and, e.g., a second wheel 134b of the car mover 80a could indicate slippage. Alternatively, a decrease in torque sensed on the first wheel 134a may result from dynamic slippage. Information on one or more of these variables may be obtained from sensor data produced by a sensor 220 that may be operationally connected to the first coil winding 210a. The sensor data may be transmitted from the sensor 220 to the car mover controller 115 via one or more transmission channels, including direct (wired connection), a wireless network 230 and via a cloud service 240 (such connections are discussed below). Processing of sensor data, to control powering of the first coil winding 210a, may occur in whole or part on the sensor 220 (e.g. via edge processing), the car mover controller 115 or the cloud service 240.

Wireless connections may apply protocols that include local area network (LAN, or WLAN for wireless LAN) protocols and/or a private area network (PAN) protocols. LAN protocols include WiFi technology, based on the Section 802.11 standards from the Institute of Electrical and Electronics Engineers (IEEE). PAN protocols include, for example, Bluetooth Low Energy (BTLE), which is a wireless technology standard designed and marketed by the Bluetooth Special Interest Group (SIG) for exchanging data over short distances using short-wavelength radio waves. PAN protocols also include Zigbee, a technology based on Section 802.15.4 protocols from the IEEE, representing a suite of high-level communication protocols used to create personal area networks with small, low-power digital radios for low-power low-bandwidth needs. Such protocols also include Z-Wave, which is a wireless communications protocol supported by the Z-Wave Alliance that uses a mesh network, applying low-energy radio waves to communicate between devices such as appliances, allowing for wireless control of the same.

Other applicable protocols include Low Power WAN (LPWAN), which is a wireless wide area network (WAN) designed to allow long-range communications at a low bit rates, to enable end devices to operate for extended periods of time (years) using battery power. Long Range WAN (LoRaWAN) is one type of LPWAN maintained by the LoRa Alliance, and is a media access control (MAC) layer protocol for transferring management and application messages between a network server and application server, respectively. Such wireless connections may also include radio-frequency identification (RFID) technology, used for communicating with an integrated chip (IC), e.g., on an RFID smartcard. In addition, Sub-1 Ghz RF equipment operates in the ISM (industrial, scientific and medical) spectrum bands below Sub 1 Ghz—typically in the 769-935 MHz, 315 Mhz and the 468 Mhz frequency range. This spectrum band below 1 Ghz is particularly useful for RF IOT (internet of things) applications. Other LPWAN-IOT technologies include narrowband internet of things (NB-IOT) and Category M1 internet of things (Cat M1-IOT). Wireless communications for the disclosed systems may include cellular, e.g. 2G/3G/4G (etc.). The above is not intended on limiting the scope of applicable wireless technologies.

Wired connections may include connections (cables/interfaces) under RS (recommended standard)-422, also known as the TIA/EIA-422, which is a technical standard supported by the Telecommunications Industry Association (TIA) and which originated by the Electronic Industries Alliance (EIA) that specifies electrical characteristics of a digital signaling circuit. Wired connections may also include (cables/interfaces) under the RS-232 standard for serial communication transmission of data, which formally defines signals connecting between a DTE (data terminal equipment) such as a computer terminal, and a DCE (data circuit-terminating equipment or data communication equipment), such as a modem. Wired connections may also include connections (cables/interfaces) under the Modbus serial communications protocol, managed by the Modbus Organization. Modbus is a master/slave protocol designed for use with its programmable logic controllers (PLCs) and which is a commonly available means of connecting industrial electronic devices. Wireless connections may also include connectors (cables/interfaces) under the PROFibus (Process Field Bus) standard managed by PROFIBUS & PROFINET International (PI). PROFibus which is a standard for fieldbus communication in automation technology, openly published as part of IEC (International Electrotechnical Commission) 61158. Wired communications may also be over a Controller Area Network (CAN) bus. A CAN is a vehicle bus standard that allow microcontrollers and devices to communicate with each other in applications without a host computer. CAN is a message-based protocol released by the International Organization for Standards (ISO). The above is not intended on limiting the scope of applicable wired technologies.

In one embodiment, second tire coil winding 210b is disposed on the second tire 135b of the second wheel 134b, which rides on an opposing side of the car mover track 85 from the first tire 135a. Magnetic polarity of the electromagnets may be configured to draw the first and second tires 135a, 135b toward each other to increase traction. In addition, if the sensor 220 senses that the first tire 135a is dragging, e.g. due to a debris, the polarity of the first coil winding 210a in it may be momentarily reversed to enable the first and second tires 135a, 135b to quickly move away from the car mover track 85 and dislodge the debris. If this action does not succeed, a maintenance alert may be created by the controller 115 and transmitted to a service hub 250 for the elevator system 10.

With the disclosed embodiments, the first tire 135a is warmed by the first coil winding 210a to provide a greater amount of traction. An electromagnetic force is also added by the first coil winding 210a to provide traction and thereby decrease a required amount of clamping force and a surface area required to generate normal forces and suspend the car mover 80a. Ferrous material that may be attracted by the first coil winding 210a may be released when the first coil winding 210a is turned off.

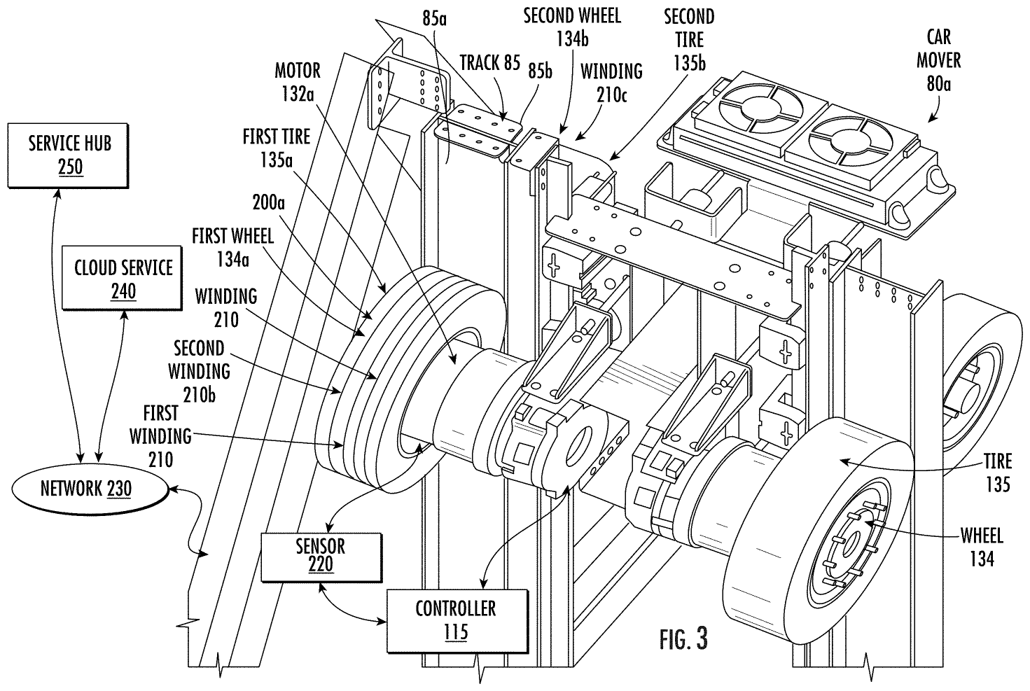

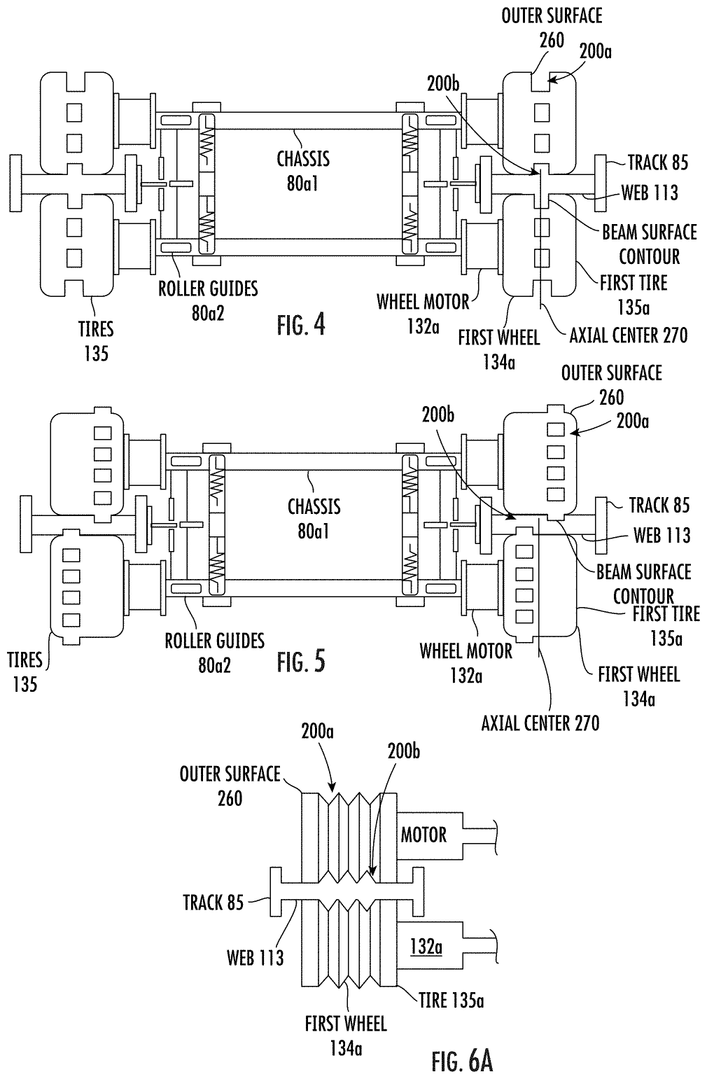

Turning to FIGS. 4-6, an embodiment is shown where the tires 135 have a tire engagement features 200a and the web 113 of the car mover track 85 (shown as an I-beam) has a track engagement feature 200. In FIGS. 4-6, for reference, the chassis 80a1 and roller guides 80a2 of the car mover 80a are shown and labeled. The tire and track engagement features 200a, 200b (which may be referred to as engagement features 200a, 200b) are the form of matching surface profiles that provide for increased traction along the travelling path. For simplicity the first tire 135a and the first wheel 134a will again be the focus of this discussion as the tires 135 and wheels 134 have the same features. In some embodiments (e.g., as shown in FIG. 3), the first tire 135a is a traction tire that travels on a flat steel beam surface formed by the web 113 of the car mover track 85. The features shown in FIGS. 4-6 address challenges of maintaining traction between the first tire 135a and the car mover track 85 while potentially reducing a required normal force.

More specifically, as illustrated in FIG. 4 the engagement features 200a, 200b can be in the form of protrusions extending from the web 113 of car mover track 85 that engages complementary impressions (or slots) in the first tire 135a. As illustrated in FIG. 5 the engagement features 200a, 200b may also be in the form of slots (or impressions, or holes) in the web 113 of the car mover track 85 that engage protrusions on the first tire 135a.

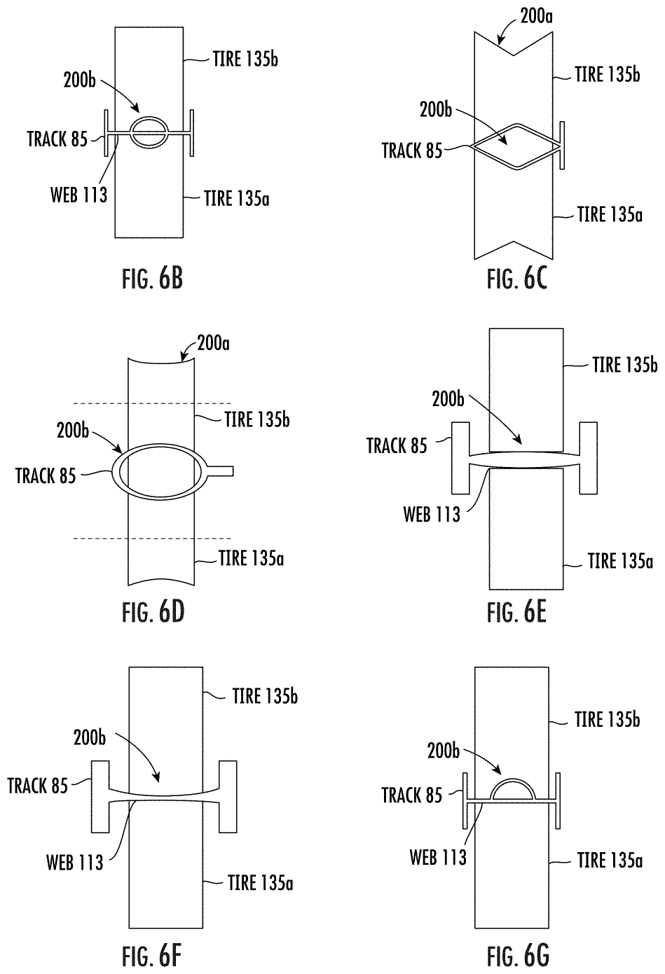

FIG. 6A illustrates another embodiment of a non-flat running surface. In this case, the engagement features 200a, 200b include multiple V-shaped contours on the first tire 135a resulting in a plurality of raised tire grooves (e.g., forming wedges, ridges or a triangular waveform profile), that engage complimentary grooves on the web 113 of the car mover track 85. The embodiment of FIG. 6A provides greater contact area between first tire 135a and the car mover track 85, which results in a greater traction, and reduced coefficient of friction requirement.

FIG. 6B shows tires 135a, 135b and a web 113 of the car mover track 85. The web has engagement features 200b in the form of semi-circular shaped protrusions, forming semi-circular profile, on both sides of the web 113 to provide enhanced traction. FIG. 6C shows tires 135a, 135b and the car mover track 85 having engagement features in the form of a wedge or diamond shaped track features 200b, forming a wedge or diamond shaped profile, and complementary impressions forming engagement features 200a in the tires 135a, 135b, to provide enhanced traction. FIG. 6D shows tires 135a, 135b and the car mover track 85 having engagement features in the form of a track with features 200b defined by a circular section, forming a circular profile, and complementary impressions forming engagement features 200a on the tires 135a, 135b, to provide enhanced traction. FIG. 6E shows tires 135a, 135b and a web 113 of the car mover track 85. The web 113 has engagement features 200b in the form of a convex cross section, forming a convex profile, to provide enhanced traction. FIG. 6F shows tires 135a, 135b and a web 113 of the car mover track 85. The web 113 has engagement features 200b in the form of a concave cross section, forming a concave profile, to provide enhanced traction. FIG. 6G shows tires 135a, 135b and a web 113 of the car mover track 85. The web 113 has engagement features 200b in the form of a semi-circular shaped protrusion, forming a semi-circular profile, on one side of the web 113, to enhance guidance. The semi-circular profile of FIG. 6G is merely exemplary so that another other geometric feature 200b will provide the same benefit of enhanced guidance.

Thus, the disclosed embodiments in FIGS. 4-6 provide non-flat and/or non-solid beam surface which allows mechanical engagement rather than pure traction between the first tire 135a and the car mover track 85. As can be appreciated, the surface contours shown in FIGS. 4-6 extend circumferentially about the outer annular surface 260 of the first tire 135a. The engagement features 200a in FIG. 4 runs along the axial center 270 of the first tire 135a, though the engagement features 200a in FIG. 5 is offset from the axial center 270.

The embodiments shown in FIGS. 4-6 provide a benefit of a reduced normal force requirement and traction requirement between the first tire 135a and the car mover track 85, which may help prolong tire life and enhance system operation. The engagement features 200a, 200b also provide enhanced tracking/steering of the car mover 80a while in motion.

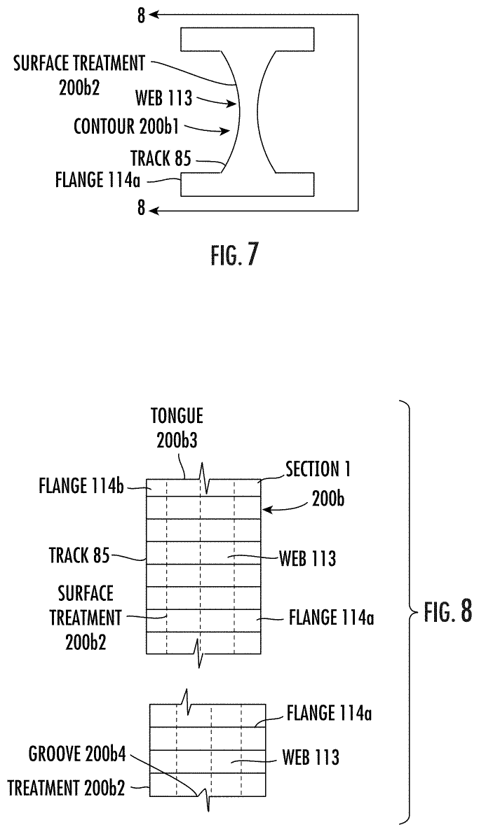

Turning to FIGS. 7-8, in a hub-wheel-motor based elevator system 10 as disclosed herein, the car mover 80a may rely on the web 113 of the car mover track 85 for traction. The web 113 should provide a sufficient coefficient of friction and ensure the tires 135 of the car mover 80a remains centered on the web 113. For this embodiment, as with the other embodiments here, reference shall be to the first tire 135a and the first wheel 134a as the tires 135 and wheels 134, and engagement with the car mover track 85, are substantially the same.

As shown in FIGS. 7-8, the track engagement features 200b, provided on the car mover track 85 (illustrated as an I-beam), includes a rounded (concave profile) shape (or surface contour) 200b1 for the web 113 (both sides). The concave shape of the web 113 increase the contact area with the first tire 135a, thus increasing the coefficient of friction, and also to ensure self-tracking of the first tire 135a.

In addition, the track engagement features 200b include a friction enhanced surface treatment (or surface coating) 200b2 applied to the car mover track 85. E.g., an asphalt coating or similar coating may be applied that provides the same or similar friction qualities. Some embodiments provide an anti-corrosion coating that results in a greater coefficient of friction. The disclosed embodiments also provide for varying the surface finish of the web 113 to provide an increase surface friction

The car mover track 85 may include, as track engagement features 200b, complimentary alignment features 200b3, 200b4, respectively illustrated as tongue and groove connector features, formed in the web 113, e.g., midway between end flanges 114a, 114b. The alignment features 200b3, 200b4 may assure proper alignment between sections of the car mover track 85 (only one section is shown). The alignment features 200b3, 200b4 may enable a quick install as well.

The disclosed embodiments of FIGS. 7-8 provide greater traction characteristics between the car mover 80a and the car mover track 85. This may keep the car mover 80a centered on the web 113 as well as help manage noise, provide for a relatively quick install process, and provide for a more accurate alignment.

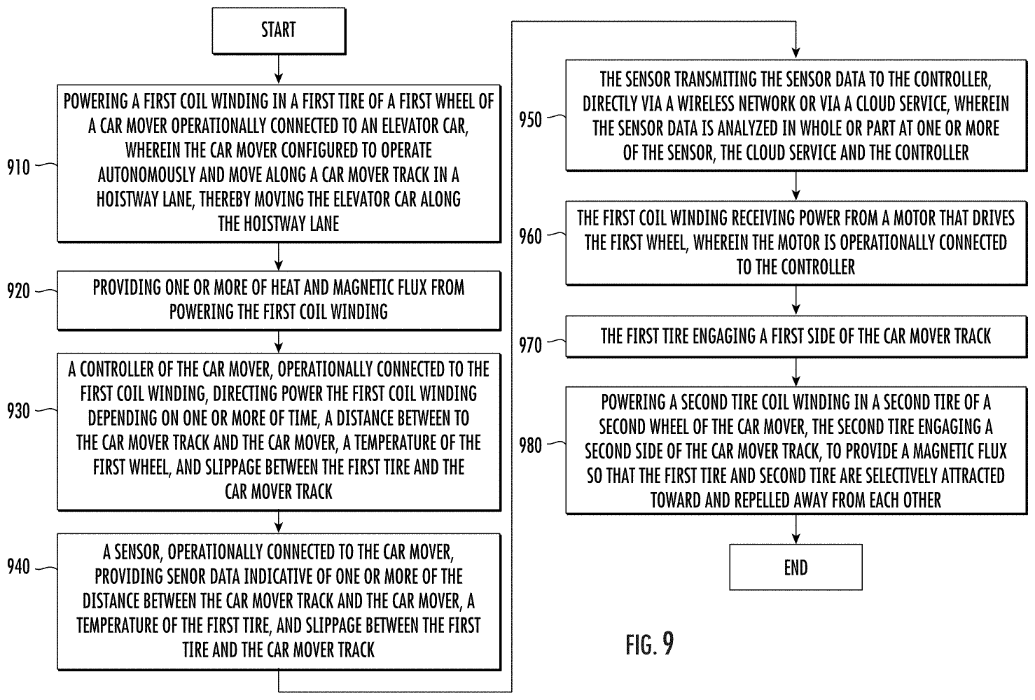

Turning to FIG. 9, a flowchart shows a method of operating a ropeless elevator system 10. As shown in block 910 the method includes powering a first coil winding 210a in a first tire 135a of a car mover 80a, operationally connected to an elevator car 50a. As indicated, the car mover 80a is configured to operate autonomously and move along a car mover track 85 in a hoistway lane 60, thereby moving the elevator car 50a along the hoistway lane 60.

As shown in block 920, the method includes providing one or more of heat and magnetic flux from powering the first coil winding 210a.

As shown in block 930, the method includes a controller 115 of the car mover 80a, operationally connected to the first coil winding 210a, directing power the first coil winding 210a depending on one or more of time, a distance between to the car mover track and the car mover, a temperature of the first tire 135a, and slippage between the first tire 135a and the car mover track 85.

As shown in block 940, the method includes a sensor 220, operationally connected to the car mover 80a, providing sensor data indicative of one or more of the distance between the car mover track 85 and the car mover 80a, a temperature of the first tire 135a, and slippage between the first tire 135a and the car mover track 85.

As shown in block 950, the method includes the sensor 220 transmitting the sensor data to the controller 115, directly, via a wireless network 230 or via a cloud service 240. The sensor data is analyzed in whole or part at one or more of the sensor 220, the cloud service 240 and the controller 115.

As shown in block 960, the method includes the first coil winding receiving power from a motor 132a that drives the first wheel 134a. The motor 132a is operationally connected to the controller 115.

As shown in block 970, the method includes the first tire 135a engaging a first side 85a of the car mover track. As shown in block 980, the method includes powering a second tire coil winding 210c in a second tire 135b of a second wheel 134b of the car mover 80a, the second tire 135b engaging a second side 85b of the car mover track 85, to provide a magnetic flux so that the first tire 135a and second tire 135b are selectively attracted toward and repelled away from each other.

As described above, embodiments can be in the form of processor-implemented processes and devices for practicing those processes, such as processor. Embodiments can also be in the form of computer program code (e.g., computer program product) containing instructions embodied in tangible media (e.g., non-transitory computer readable medium), such as floppy diskettes, CD ROMs, hard drives, or any other non-transitory computer readable medium, wherein, when the computer program code is loaded into and executed by a computer, the computer becomes a device for practicing the embodiments. Embodiments can also be in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an device for practicing the exemplary embodiments. When implemented on a general-purpose microprocessor, the computer program code segments configure the microprocessor to create specific logic circuits.

The terminology used herein is for the purpose of describing particular embodiments only and is not intended to be limiting of the present disclosure. The term “about” is intended to include the degree of error associated with measurement of the particular quantity and/or manufacturing tolerances based upon the equipment available at the time of filing the application. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

Those of skill in the art will appreciate that various example embodiments are shown and described herein, each having certain features in the particular embodiments, but the present disclosure is not thus limited. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

What is claimed is:

1. A ropeless elevator system comprising:
a car mover operationally connected to an elevator car, the car mover configured to move along a car mover track in a hoistway lane, thereby moving the elevator car along the hoistway lane,
wherein the car mover includes a first tire of a first wheel that is configured to engage the car mover track when the car mover moves along the car mover track, wherein one or more of the first tire and the car mover track includes an engagement feature for increasing traction between the first tire and the car mover track.

2. The system of claim 1, wherein:
the first tire includes the engagement feature, wherein the engagement feature includes a first coil winding configured for being powered to provide one or more of heat and magnetic flux.

3. The system of claim 2, wherein:
the first coil winding is configured for being powered to provide heat and a second coil winding configured for being powered to provide magnetic flux.

4. The system of claim 2, wherein:
a controller of the car mover is operationally connected to the first coil winding and configured to direct power to the first coil winding depending on one or more of time, a distance between to the car mover track and the car mover, a temperature of the first tire, and slippage between the first tire and the car mover track.

5. The system of claim 4, wherein:
a sensor is operationally connected to the car mover and configured to provide sensor data indicative of one or more of the distance between the car mover track and the car mover, the temperature of the first tire, and slippage between the first tire and the car mover track.

6. The system of claim 5, wherein:
the sensor transmits the sensor data to the controller directly, via a wireless network or via a cloud service, and wherein the sensor data is analyzed in whole or part at one or more of the sensor, the cloud service and the controller.

7. The system of claim 4, wherein:
the first coil winding receives power from a motor that drives the first wheel, wherein the motor is operationally connected to the controller.

8. The system of claim 2, wherein:
the first tire engages a first side of the car mover track; and
the car mover includes a second tire of a second wheel that engages a second side of the car mover track, wherein the second tire includes a second tire coil winding configured for being powered to provide magnetic flux so that the first tire and the second tire are either attracted toward or repelled away from each other.

9. The system of claim 1, wherein:
the car mover track includes a track engagement feature that is configured to enhance one or more of traction and guidance when engaged by the first tire.

10. The system of claim 9, wherein:
the track engagement feature is one or more of: a track cross section of the car mover track that forms a diamond profile or a circular profile; and a track web cross section of the car mover track that forms a convex profile, a concave profile, or a semi-circular profile on one side or both sides of the of the car mover track.

11. The system of claim 1, wherein:
the first tire includes a tire engagement feature and the car mover track includes a track engagement feature, wherein the tire engagement feature and the track engagement feature are located and shaped to complement each other and engage each other when the car mover moves along the car mover track.

12. The system of claim 11, wherein:
the tire engagement feature is one of protrusions and impressions formed circumferentially along an outer annular surface of the first tire; and
the track engagement feature is another of protrusions and impressions along the car mover track.

13. The system of claim 12, wherein:
the tire engagement feature is axially centered or offset from an axial center of the first tire; or
the tire engagement feature and the track engagement feature form a triangular waveform profile.

14. The system of claim 1, wherein:
the car mover track includes the engagement feature,
wherein the engagement feature is one or more of:
a surface coating; a surface finish; a surface contour that centers the first tire on the car mover track when the car mover moves along the car mover track, and complimentary alignment features between track sections.

15. A method of operating a ropeless elevator system comprising:
powering a first coil winding in a first tire of a first wheel of a car mover operationally connected to an elevator car, wherein the car mover configured to move along a car mover track in a hoistway lane, thereby moving the elevator car along the hoistway lane; and
providing one or more of heat and magnetic flux from powering the first coil winding.

16. The method of claim 15, comprising:
a controller of the car mover, operationally connected to the first coil winding, directing power the first coil winding depending on one or more of time, a distance between to the car mover track and the car mover, a temperature of the first tire, and slippage between the first tire and the car mover track.

17. The method of claim 16, comprising:
a sensor, operationally connected to the car mover, providing sensor data indicative of one or more of the distance between the car mover track and the car mover, a temperature of the first tire, and slippage between the first tire and the car mover track.

18. The method of claim 17, comprising:
the sensor transmitting the sensor data to the controller, directly, via a wireless network or via a cloud service, wherein the sensor data is analyzed in whole or part at one or more of the sensor, the cloud service and the controller.

19. The method of claim 16, comprising:
the first coil winding receiving power from a motor that drives the first wheel, wherein the motor is operationally connected to the controller.

20. The method of claim 15, comprising:
the first tire engaging a first side of the car mover track; and
powering a second tire coil winding in a second tire of a second wheel of the car mover, the second tire engaging a second side of the car mover track, to provide magnetic flux so that the first tire and the second tire are selectively attracted toward and repelled away from each other.
